(19) United States
(12) Patent Application Publication
(10) Pub. No.: US 2009/0184035 A1
(43) Pub. Date: Jul. 23, 2009

(54) Chlorinator system for gravity-fed wastewater treatment systems

(76) Inventor: Michael R. Braden, Columbus, TX (US)

Correspondence Address: CRAIN, CATON & JAMES, FIVE HOUSTON CENTER, 1401 MCKINNEY, 17TH FLOOR, HOUSTON, TX, 77010, US

(21) Appl. No.: 12/413,257

(22) Filed: Mar. 27, 2009

Related U.S. Application Data
(63) Continuation-in-part of application No. 11/684,356, filed on Mar. 9, 2007.
Application No. 11/684,356 is a continuation-in-part of application No. 12/364,636, filed on Feb. 3, 2009.

(51) Int. Cl. C02F 1/76

(52) U.S. Cl. 210/97

(57) ABSTRACT

A chlorinator for wastewater treatment systems having a clarifier tank connected by a fluid line to a pump tank, which includes a reservoir of disinfectant fluid and a dosage container communicating with the reservoir, and a siphon communicating with the fluid line and dosage contain to dispense a determined quantity of disinfectant to the pump tank after flow through the fluid line has dropped below the flow rate of a drain in the siphon. The dosage container is vented to atmosphere to prevent vacuum lock in operation and communicates with the reservoir at a flow rate substantially smaller than it communicates with the siphon. Flow through the fluid line induces priming of a siphon for subsequent distribution of the quantity of disinfectant fluid into the pump tank after flow through the fluid line has dropped below the flow rate of a drain in the siphon, at which time disinfectant is drawn from the dosage container. As the dosage container outgoing flow rate far exceeds the dosage container incoming flow rate, once the disinfectant level drops below the point of communication between the dosage container and the pump tank, no further disinfectant is drawn into the pump tank. A near-uniform volume of disinfectant fluid is thereby supplied.

### CROSS REFERENCE TO RELATED APPLICATIONS

This is a continuation-in-part of U.S. patent application Ser. No. 11/684,356, Chlorinator for wastewater treatment systems, filed Mar. 9, 2007 and of U.S. patent application Ser. No. 12/364,636, Chlorinator for wastewater treatment systems, filed Feb. 3, 2009.

### STATEMENT REGARDING FEDERALLY SPONSORED RESEARCH OR DEVELOPMENT

Not Applicable.

### BACKGROUND OF THE INVENTION

1. FIELD OF THE INVENTION

This invention related generally to chlorinators for wastewater treatment systems. More specifically, this invention is a chlorinator for wastewater treatment systems, which have a disinfectant chamber that permits a uniform volume of disinfectant to be used each cycle.

2. DESCRIPTION OF THE RELATED ART

Chlorinators, which use either solid or liquid disinfectants, are known to the prior art. Illustrative of chlorinators using solid disinfectants are U.S. Pat. No. 6,183,630 issued to Reeves on Feb. 6, 2001; U.S. Pat. No. 4,100,073 issued to Hopcroft on Jul. 11, 1978; U.S. Pat. No. 5,350,512 issued to Tang on Sep. 27, 1994; and U.S. Pat. No. 5,405,540 issued to Tang on Apr. 11, 1995. Illustrative of chlorinators using liquid disinfectants are U.S. Pat. No. 4,333,833 issued to Longley et. al. on Jun. 8, 1982; U.S. Pat. No. 4,019,983 issued to Mandt on Apr. 26, 1977 and U.S. Pat. No. 3,996,139 issued to Prince et al. on Dec. 7, 1976.

Chlorination is widely used as part of wastewater treatment systems. In practice, a disinfectant such as chlorine is introduced at a point in the wastewater treatment system after which sufficient time, either by flow into a storage tank or through a region of flow, occurs to permit the chlorine to effectively disinfect the contaminant-bearing wastewater. The amount of disinfectant added to the wastewater is referred to as the “dosage,” and is usually expressed as milligrams per liter (mg/l) or parts per million (ppm). The amount of disinfectant necessary to disinfect a particular volume of wastewater is referred to as the “demand.”

The reaction between the disinfectant and the contaminants is typically not instantaneous but is instead time dependent. In order to obtain adequate disinfection, the mixing of wastewater and disinfectant should be completed in the shortest time possible, ideally a fraction of a second. The amount of disinfectant remaining in the wastewater at the time of measurement is referred to as the “residual.” The residual is therefore determined by the demand subtracted from the dosage.

Prior art chlorinators, whether using a liquid or solid disinfectant, typically mix the disinfectant with the wastewater during the flow of wastewater through the wastewater treatment system. In the case of chlorinators using a solid disinfectant, such as those disclosed in U.S. Pat. No. 6,183,630 issued to Reeves on Feb. 6, 2001; U.S. Pat. No. 4,100,073 issued to Hopcroft on Jul. 11, 1978; U.S. Pat. No. 5,350,512 issued to Tang on Sep. 27, 1994; and U.S. Pat. No. 5,405,540 issued to Tang on Apr. 11, 1995, mixing occurs by wastewater flow about a plurality of disinfectant tablets. In such systems the disinfectant is mixed at a rate dependant on the surface area of the table in contact with the wastewater, the density of the wastewater and the flow rate of the wastewater, among other variables. In the case of chlorinators using a liquid disinfectant, such as U.S. Pat. No. 4,333,833 issued to Longley et. al. on Jun. 8, 1982 mixing occurs at a contactor in the flowline wherein disinfectant fluid is drawn from a reservoir by pressure differential. In such systems the amount of chlorine combined with the wastewater varies with the flow rate of the wastewater and wastewater density. Thus it would be beneficial to the prior art to provide a chlorinator that dispenses a uniform volume of chlorine.

Other chlorinators using liquid disinfectant are likewise known, such as those disclosed in U.S. Pat. No. 6,627,071 issued to Braden on Sep. 30, 2003 and U.S. Pat. No. 6,932,912 issued to Chaffin on Aug. 23, 2005. U.S. Pat. No. 6,627,071 issued to Braden teaches a chlorinator for wastewater treatment systems having a circulation pump and return flow line which includes a disinfectant container, rendered buoyant by a float, floating within a space internal to a tank wherein the buoyant container intakes a determined quantity of disinfectant fluid through a check valve, which terminates communication between the disinfectant container and tank during operation of a circulation pump. After cessation of the circulation pump, the check valve opens to reestablish the quantity of disinfectant fluid. As a result, operation is dependent on a functioning check value. U.S. Pat. No. 6,932,912 issued to Chaffin on Aug. 23, 2005 discloses a system that continuously supplies liquid disinfectant so long as the circulation pump is active and the volume of disinfectant can be withdrawn from a single disinfectant reservoir. Such unlimited supply of disinfectant, as a result of circulation pump action, or unknown supply of disinfectant, as a result of exhaustion of some unknown volume of disinfectant remaining in the disinfectant reservoir, may result in excessive or inadequate dosage of chlorine. It would therefore be an improvement to properly control the volume of chlorine dispensed.

Typical water treatment systems contain sequential chambers for elimination of solid waste, which would not be consumed by aerobic action, for aerobic treatment of the wastewater, for clarification of the wastewater and for storage of treated wastewater prior to disbursal to the environment. Disinfectant is mixed with the treated wastewater between clarification and disbursal. Disbursal of treated wastewater is accomplished by mechanical pumping action in the pump tank to the output system. Such systems utilize a pump to remove fluid from the pump tank. of the removal of a volume of treated wastewater from the pump tank creates space for additional treated wastewater to enter the pump tank from the clarifier, thus creating a turbulent area within the treated wastewater in the pump tank.

It would be therefore be an improvement to provide a chlorinator that dispenses a chlorine into the pump tank, without need of an additional external power supply, with no moving parts, in association with the introduction of additional wastewater to the pump tank from the clarifier.

### SUMMARY OF THE INVENTION

Accordingly, it is an object of the present invention to provide, inter alia, a chlorinator for aerobic waste treatment systems that dispenses a uniform volume of liquid disinfectant and that rapidly mixes the disinfectant fluid with the wastewater without the need for a power source, without moving parts, and in association with the introduction of additional wastewater to the pump tank from the clarifier.

Other objects of my invention will become evident throughout the reading of this application.

The invention is a chlorinator for a gravity-fed waste treatment systems, which dispenses a uniform volume of disinfectant fluid when sufficient volume of wastewater passes from a clarifier tank to a pump tank.

In one embodiment, a siphon is attached to a dosage container via a disinfectant fluid line. The dosage container is vented to atmosphere to prevent vacuum lock in operation and communicates with the reservoir at a flow rate substantially smaller than it communicates with the circulation tank. When the pump in the pump tank reduces the volume in the pump tank to permit sufficient flow from the clarifier tank to activate a siphon, the volume of dosage container is emptied into the pump tank. The dosage container refills at such a slow rate that little additional disinfectant may be withdrawn to the pump tank.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

FIG. 1 is a schematic diagram of a typical four chamber septic system.

FIG. 2 is a partial cut-away side view of the clarifier chamber and wastewater treatment system pump tank of the present invention.

FIG. 3 is a partial cut-away side view of the exemplary chlorinator.

FIG. 4 is a partial cut-away side view of an alternative chlorinator.

FIG. 5 is a cross-sectional side view of illustrating the siphon for the present invention.

### DETAILED DESCRIPTION OF THE PREFERRED EMBODIMENT

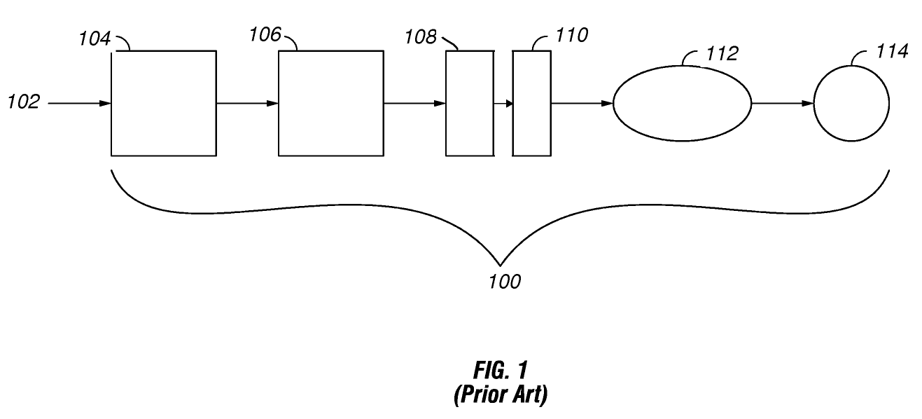

As shown in FIG. 1, a typical gravity-fed water treatment system 100 contains a series of steps that prepares wastewater 102 for release into the environment. The exemplary water treatment system 100 has a solid waste elimination chamber 104, an aerobic treatment chamber 106, a clarifier chamber 108, a chlorine addition step 112, a pump tank 110, and a disbursal step 114. This invention addresses the chlorine addition step 112.

The chlorinator of the present invention includes a disinfectant reservoir container adapted to contain a volume of disinfectant fluid therein, a dosage container designed contain a specific dosage of disinfectant received from the disinfectant reservoir container and to vent after disbursal of that dosage per cycle, and a siphon in communication with the flow line from the clarification chamber to the pump tank and primed by flow through that flow line, which draws disinfectant from the dosage container through a disinfectant fluid line for introduction to the pump tank.

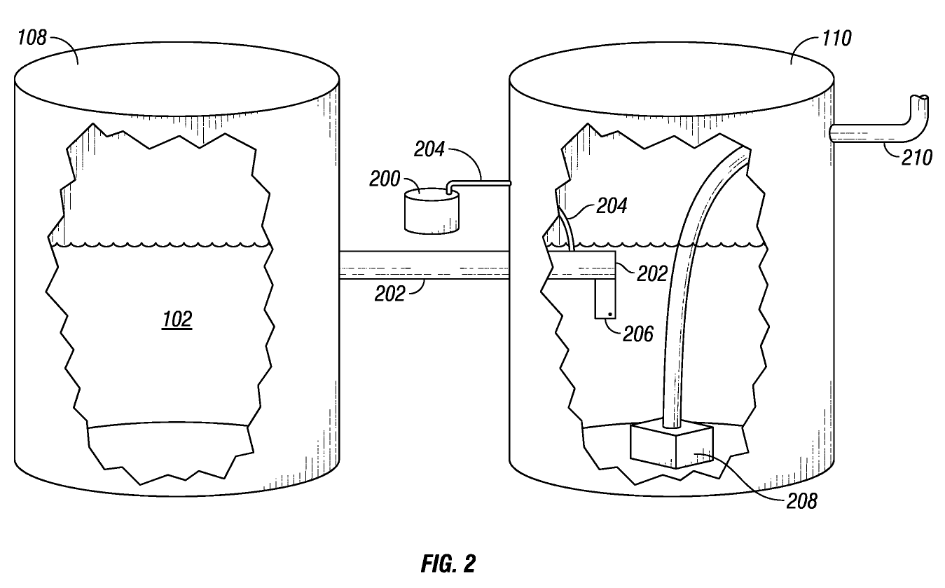

As shown in FIG. 2, the chlorinator 200 includes a siphon 206 and, while in use, disburses a uniform volume of a disinfectant fluid 302 (not shown) through a disinfectant fluid line 204 and a siphon 206 to the wastewater 102 in the pump tank 110. The disinfectant fluid line 204 therefore has a dosage container end and a siphon end. The pump tank 110 provides storage for wastewater 102 prior to being pumped by a pump 208 to the output 210. Wastewater 102 is supplied to the pump tank 110 from a clarifier chamber 108 when the volume of wastewater 102 in the pump tank 110 drops below the opening of the fluid line 202. The pump 208 operates on an intermittent basis. The pump 208 is activated either by timer or by the level of wastewater 102 and operates until the termination of the time cycle or until the wastewater 102 falls below a specific level in the pump tank 110. A siphon 206 is connected in communication with the fluid line 202 and communicates with both the fluid line 202 and the chlorinator 200 such that the siphon 206 is primed, but prevented from operating, by the flow of wastewater 102 through the fluid line 202. Thus, when the flow through the fluid line 202 ceases, the siphon 206 may activate and draw the disinfectant, up to the maximum permitted dosage, for introduction to the wastewater 102.

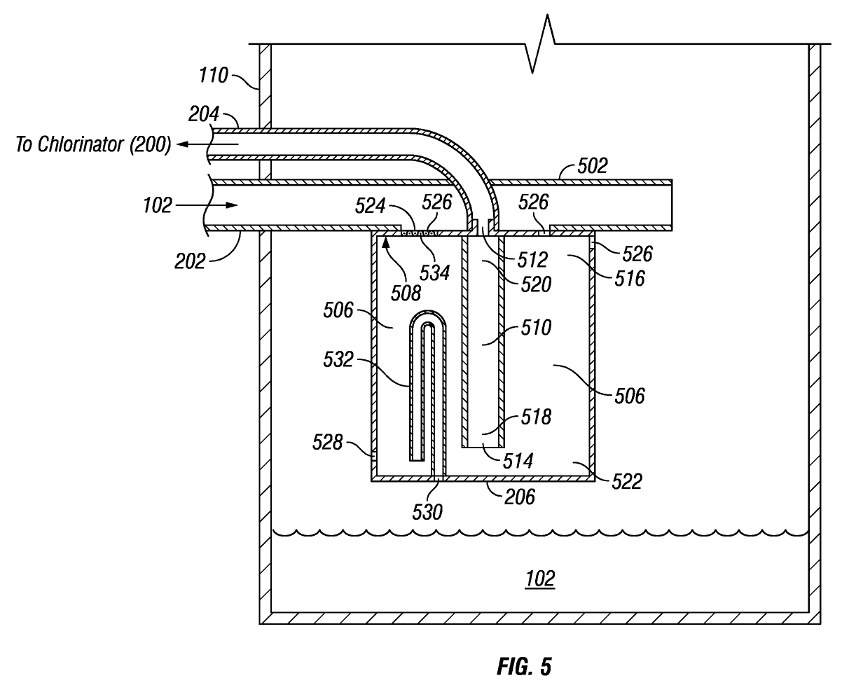

Disinfectant fluid 302 is drawn from the chlorinator 200 by use of a siphon 206 constructed to operate only after cessation or near cessation of flow through fluid line 202. Referring to FIG. 5, in the exemplary embodiment, the siphon connection 502 provides communicate between the fluid line 202 and the flow-primed siphon 206. The siphon connection 502 diverts all or a portion of the wastewater 102 to the siphon 206. A flow-primed siphon 206 is constructed to induce a siphoning action. After the flow-primed siphon 206 is primed, a vacuum is created when the flow through fluid line 202 flows into the siphon 206 at a rate less than the flow rate through the main drain 528 and the secondary drain 530 in the siphon 206. The flow-primed siphon 206 includes a first chamber 506, which includes a second, internal chamber 510 which is attached to the top inner surface 508 of the first chamber 506 and which descends into the first chamber 506. The second, internal chamber 510 is in fluid communication with the first chamber 506 at the bottom orifice or opening 514 located at the lower end 518 of the second, internal chamber 510. The second, internal chamber 510 is in fluid communication with the disinfectant fluid line 204 through a narrow opening 512 at the upper end 520 of the second, internal chamber 510. Thus, the disinfectant line 204 is in fluid communication with the siphon 206. The flow-primed siphon 206 further includes an inlet 524, and a vent 526 and main drain 528 and the secondary drain 530. In the preferred embodiment, the vent 526 also functions as an outlet for overflow of the wastewater 102 in the siphon 206. The vent/outlet 526 may also be a one-way valve, permitting the exit of air and wastewater 102 from the siphon 206, but generating a vacuum in the siphon 206 once the siphon 206 is filled with wastewater 102 and the main drain 528 begins permitting fluid to exit the siphon 206. When the vent/outlet 526 is a one-way valve, second, internal chamber 510 may be omitted from siphon 206. In the preferred embodiment the inlet 524, the narrow opening 512 and the vent/outlet 526 are positioned at, near or proximate the upper end 516 of the first chamber 506 while the main drain 528 and the secondary drain 530 are positioned at, near or proximate the lower end 522 of the first chamber 506. The vent/outlet 526 should be positioned near or proximate the upper end 516 of the first chamber 506 to ensure priming of the siphon 206. The inlet 524 is in fluid communication with flow from the clarifier chamber 108 while the vent/outlet 526 communicates to the pump tank 110. Ideally, the inlet 524 is positioned near or proximate the upper end 516 of the first chamber 506. The inlet 524 and the vent/outlet 526 are sized to ensure no restriction in flow in the fluid line 202. The inlet 524 and the vent/outflow 526 may be combined and/or covered with a screen or grate 534 at the siphon connection 502. Alternatively, more than one vent/outflow 526 may be utilized, including a vent/outflow 526 positioned to communicate directly to the pump tank 110. The main drain 528, in all situations, is sized for a flow rate less, preferably substantially less, than the flow rate through the vent/outlet 526. In operation, the pump 208 is engaged by the wastewater treatment system 100, reducing the volume of wastewater 102 in the pump tank 110 below the level of the wastewater 102 in clarifier chamber 108 and thereby permitting flow of the wastewater 102 from the clarifier chamber 108 to the pump tank 110 through the fluid line 202. As water from the fluid line 502 enters the first chamber 506, it fills the first chamber 506 and the second, internal chamber 510, then exits the flow-primed siphon 206 via the vent/outlet 526. The second, internal chamber 510 is sized to create a siphoning effect, so after the flow has ceased or reduced to a rate less than the flow rate through the main drain 528 in the siphon 206 and the water drains from the first chamber 506 through the main drain 528, the height of water in the second, internal chamber 510 pull a vacuum on the disinfectant fluid line 204, drawing the disinfectant 302 from the chlorinator 200 into the second, internal chamber 510 to be drained into the pump tank 110 via the main drain 528. Once the water drains below the second, internal chamber 510 in first chamber 506, the siphon 206 ceases operation and no further disinfectant fluid 302 is drawn, assuming the chlorinator 206 has not vented to air by that time and terminated the siphon effect.

In a further embodiment, the siphon 206 may further include a secondary drain 530 which may be a loop 532 in the siphon 206, draining to the pump tank 110 and including an opening proximate the lower end 522 of the first chamber 506 of the siphon 206. In operation, should the wastewater 102 in the siphon 206 exceed the height of loop 532, the wastewater 102 in loop 532 will create its own siphoning action, permitting rapid removal of wastewater 102 from the siphon 206.

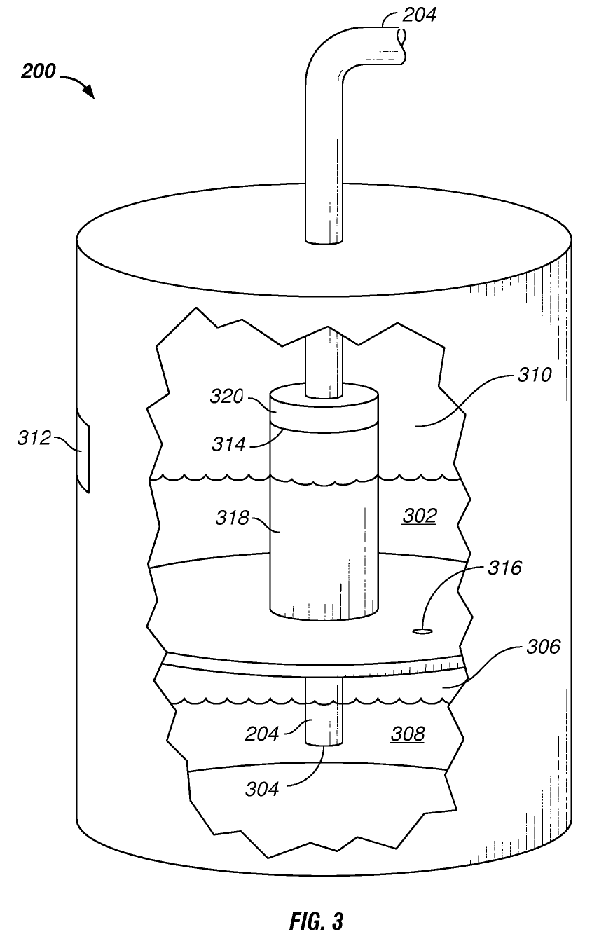

Referring to FIGS. 2, and 3 when the siphon 206 is active, disinfectant fluid 302 is withdrawn from the chlorinator 200. In the exemplary embodiment, the flow-primed siphon 206 draws disinfectant fluid 302 through the disinfectant fluid line 204, which terminates in the dosage container 306. The disinfectant fluid line 204 is thus in fluid communication with the dosage container 306. When the portion of the fluid disinfectant volume 308 above the bottom orifice 304 of the disinfectant fluid line 204 is withdrawn, the chlorinator 200 ceases to supply additional disinfectant fluid 302 and instead supplies air, which is drawn from the reservoir container 310 via the chlorinator vent member 318. As depicted in FIG. 3, the chlorinator vent member 318 may be located to pass through the reservoir container 310, and may then have a valve or float 320 to prevent fluid communication to the dosage container 306 from the reservoir container 310. Preferably where the chlorinator vent member 318 passes through the reservoir container 310, the reservoir container 310 has an overfill exit 312 or other apparatus known in the art to prevent the filling of the reservoir container 310 above the top 314 of the chlorinator vent member 318. Thus, the chlorinator vent member 318 is in communication with the dosage container 306. In the exemplary embodiment, as the dosage container 306 draws air from within the chlorinator 200, which is relatively saturated with disinfectant gas, thereby possessing less capacity to degrade the disinfectant fluid with which it comes in contact. In the exemplary embodiment, as the dosage container 406 draws air from within the chlorinator 200, which is relatively saturated with disinfectant gas, thereby possessing less capacity to degrade the disinfectant fluid with which it comes in contact. In the preferred embodiment, the disinfectant fluid line 204 communicates with the dosage container 306 by passing through the chlorinator vent member 318, which passes through the reservoir container 310.

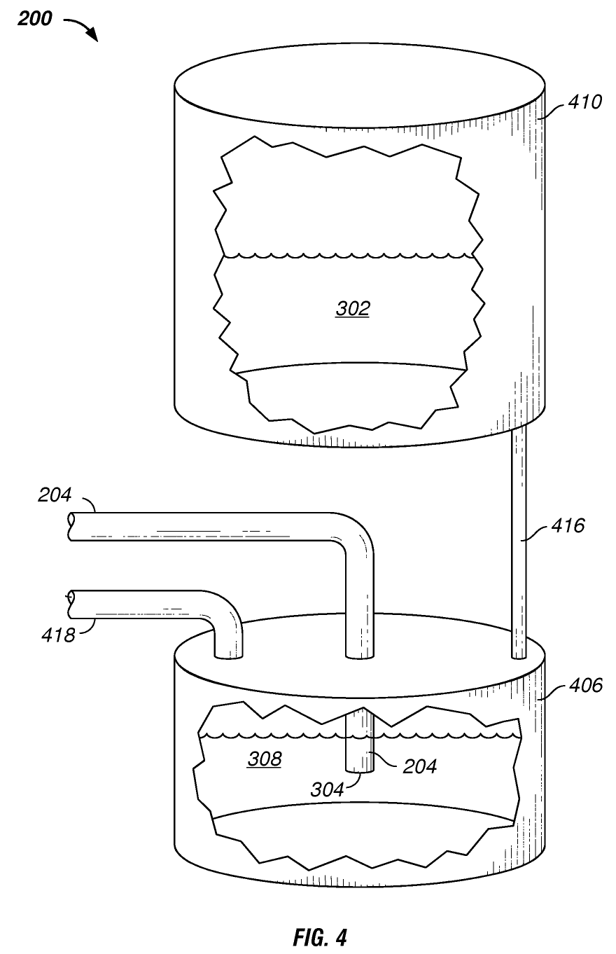

Alternatively, as depicted in FIG. 4, the dosage container 406 and the reservoir container 410 may be separated, joined by a dosage passageway 416, constructed as a piping. The chlorinator vent member 418 may be located to pass to atmosphere.

The fluid disinfectant volume 308 is replenished via the dosage passageway 316. The dosage passageway 316 is sized that the flow rate of the disinfectant fluid 302 through the disinfectant fluid line 204 during operation so far exceeds the flow rate of the disinfectant fluid 302 through the dosage passageway 316 that the additional inflow of the disinfectant fluid 302 during operation of the pump 208 is negligible compared to the total volume of the disinfectant fluid 302. The dosage passageway 316 provides fluid communication between the dosage container 306 and the disinfectant reservoir container 310. In the preferred embodiment, the disinfectant fluid line 204 is at least five times the cross sectional area of the dosage passageway 316. The dosage passageway 316 may be located at the interface between the reservoir container 310 and the dosage container 306, or through the chlorinator vent member 318 where the chlorinator vent member 318 passes through the reservoir container 310. Alternatively, the dosage passageway 316 may be piping connecting the reservoir container 310 and the dosage container 306.

There is essentially no increase in the disinfectant fluid volume 308 during operation of the siphon 206. Once the level of the fluid disinfectant 302 drops below the bottom orifice 306 of the disinfectant fluid line 204, no further disinfectant fluid 302 is drawn into the pump tank 110.

The volume withdrawn during operation of the chlorinator 200 may be adjusted by resizing of the dosage container 306 or by adjustment of the location of the bottom orifice 304 of the disinfectant fluid line 204. A smaller dosage container 306 or positioning of the bottom orifice 304 of the disinfectant fluid line 204 higher in the dosage container 306 will result in less disinfectant being added per cycle of the siphon 206. Likewise a larger dosage container 306 or positioning of the bottom orifice 304 of the disinfectant fluid line 204 lower in the dosage container 306 will result in more disinfectant being added per cycle of the siphon 206.

In operation, the chlorinator vent member 318 may be removably attached to the dosage container 306, preferably by a threaded connection. Likewise, the reservoir container 310 may be sized to accept a dosage container 306 via a press-fit at its lower-most point.

The terms and expressions which have been employed in the foregoing specification are used therein as terms of description and not of limitation, and there is no intention, in the use of such terms and expressions, of excluding equivalents of the features shown and described or portions thereof.

I claim:

1. A chlorinator for a wastewater treatment system,
said wastewater treatment system having a clarifier tank connected by a fluid line to a pump tank,
said chlorinator comprising:
a disinfectant reservoir container adapted to contain a volume of disinfectant fluid therein;
a dosage container;
a siphon operably connectable to said fluid line, said siphon comprising
a first chamber, said first chamber having an inlet, a vent, and a drain, said first chamber having an top inner surface, said first chamber having a upper end and a lower end, said drain positioned proximate said first chamber lower end, said vent positioned proximate said first chamber upper end, said inlet adapted for fluid communication with said fluid line; and
a second chamber, said second chamber internal said first chamber and in fluid communication with said first chamber and attached to said first chamber and descending downwardly into said first chamber, said second chamber having a lower end, said second chamber having an opening at said second chamber lower end, said second chamber having an upper end, said second chamber having an opening at said second chamber upper end, said second chamber adapted for fluid communication with a fluid disinfectant line through said opening; said second chamber sized to siphon said fluid disinfectant from said fluid disinfectant line during siphon-emptying drainage of first chamber through said drain;
said disinfectant fluid line having a dosage container end and a siphon end, said disinfectant fluid line in fluid communication with said dosage container and in fluid communication with said siphon;
said dosage container in fluid communication of said disinfectant reservoir container via a dosage passageway; and
a venting member, said venting member in communication with said dosage container.

2. The chlorinator of claim 1 wherein:
said dosage passageway is located in said venting member.

3. The chlorinator of claim 2 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.

4. The chlorinator of claim 1 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.

5. A chlorinator for a wastewater treatment system, said wastewater treatment system having a clarifier tank connected by a fluid line to a pump tank,
said chlorinator comprising:
a disinfectant reservoir container adapted to contain a volume of disinfectant fluid therein;
a dosage container, said dosage container in fluid communication of said disinfectant reservoir container via a dosage passageway;
a siphon adapted for communication with said fluid line and adapted to siphon from said dosage container and to drain to said pump tank; and
a venting member, said venting member in communication with said dosage container.

6. The chlorinator of claim 5 wherein:
said dosage passageway is located in said venting member.

7. The chlorinator of claim 6 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.

8. The chlorinator of claim 5 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.
